(19) United States
(12) Patent Application Publication
(10) Pub. No.: US 2005/0140240 A1
(43) Pub. Date: Jun. 30, 2005

(54) Rotor, especially a short-circuit rotor for an electric machine, amd electric machine with a rotor

(76) Inventors: Kurt Reutlinger, Stuttgart (DE); Karl-Juergen Roth, Schwieberdingen (DE)

Correspondence Address: Striker Striker & Stenby, 103 East Nedk Road, Huntington, NY, 11743, US

(21) Appl. No.: 10/510,863

(22) PCT Filed: Jun. 12, 2003
(86) PCT No.: PCT/DE03/01958

(30) Foreign Application Priority Data
Jun. 14, 2002 (DE) 10226574.7

(51) Int. Cl. H02K 1/00

(52) U.S. Cl. 310/216

(57) ABSTRACT

A rotor for an electrical machine (30), in particular a short-circuited rotor for an asynchronous machine, is proposed, whereby teeth (16) and grooves (13) alternate on the periphery, and the groove spacing (τₙ) is not constant.

### BACKGROUND INFORMATION

An asynchronous machine and/or a short-circuited rotor for an electrical machine with which the groove spacing is constant is made known in the book “Elektrontechnik—Fachkunde für Elektroberufe”, published by W. Girardet, Essen, 1980, page 234 ff. The disadvantage of short-circuited rotor designs of this type is that, despite the use of diverse, known design specifications that relate to the number of rotor grooves to use, the short-circuited rotor machines originally assessed as being quiet prove to be surprisingly extraordinarily noisy on the test stand. Even a diagonal orientation, i.e., a non-axial orientation of the rotor grooves, has proven unsuitable in many cases.

### ADVANTAGES OF THE INVENTION

The rotor according to the present invention having the features of the main claim has the advantage that certain harmonic waves of the air gap field, which cause the electromagnetic noise by way of their pulsating forces and pulsating torques on the stator core, are weakened or eliminated entirely. A torque irregularity and/or torque ripple is also reduced.

Advantageous further developments of the rotor according to the main claim are possible due to the measures listed in the subclaims. A particularly favorable weakening of the pulsating forces and pulsating torques on the stator core is achieved when the groove spacing on the periphery is alternatingly larger and smaller; this has a particularly advantageous effect when the groove spacing on the periphery approximates a sine-dependent function.

A further enhanced result in terms of pulsating forces and pulsating torques was achieved by increasing and decreasing the groove spacing around the periphery twice.

According to a further configuration of the present invention, to prevent loss of power of the short-circuited rotor machine, the ratio of groove width to groove spacing is constant for each tooth.

An imbalanced state is largely prevented by using a symmetrical rotor configuration.

According to an independent claim, an electrical machine is also provided that includes a stator and a rotor according to the present invention.

### DRAWING

An exemplary embodiment of a rotor according to the present invention and an electrical machine according to the present invention are shown in the embodiments.

FIG. 1 shows a side view of a rotor according to the present invention, and

FIG. 2 shows an electrical machine in a schematic depiction.

### DESCRIPTION

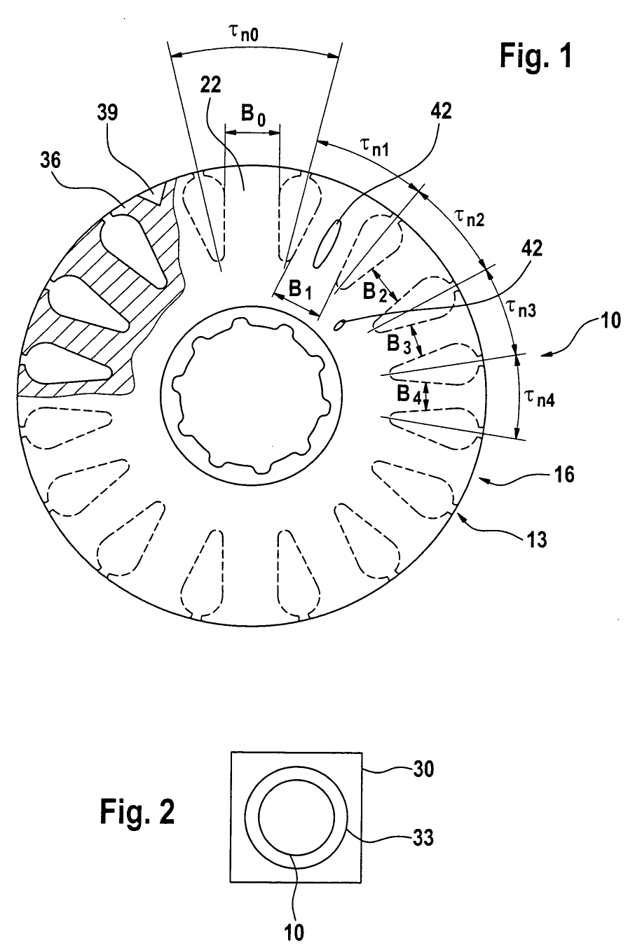

A side view of a rotor 10 according to the present invention is shown in FIG. 1. Rotor 10 has grooves 13 and teeth 16, which alternate on the periphery of rotor 10. A bar 19 is inserted in each groove 13, the bars being connected with each other by known short-circuiting rings at the two axial ends of rotor 10.

Each tooth 16 has a tooth width B, referred to here as the width of root 22. In the example shown in FIG. 1, a rotor 10 having a total of sixteen teeth 16 is shown, whereby rotor 10 has an axially symmetrical configuration and a point-symmetrical configuration relative to the center of rotor 10. A tooth 16 with a smaller width B₁ abuts a broadest tooth 16 having a width B⁰ in the clockwise direction. Abutting this, in turn, in the same direction, is an even narrow tooth 16 with a width B₂ and, abutting this is a tooth 16 with a width B₃. A narrowest tooth 16 is located in the approximately “3 o'clock” position and has width B₄. Each tooth 16 has a groove spacing τₐ. Abutting tooth 16 with the largest groove spacing τₙ₀ on each side is a tooth 16, each having a smaller groove spacing τₙ, resulting, in entirety, in a rotor 10 for an electrical machine and, in this case in particular, a short-circuited rotor for an asynchronous machine with which the groove spacings τ are not constant.

Abutting the narrowest tooth 16 in the “3 o'clock” position, continuing in the clockwise direction, is a subsequently broader tooth 16 in each case, until a broadest tooth 16 is reached again in the “6 o'clock” position. Due to the point-symmetry or the axial symmetry, an alternatingly increasing and decreasing groove spacing τ results on the periphery. As the computing rule for determining the groove spacing on the periphery, in particular with regard for their alternatingly increasing and decreasing extents, it is provided that groove spacing τ is a sine-dependent or nearly sine-dependent function.

As shown in FIG. 1, it is provided that groove spacing τ increases and decreases twice around the periphery of rotor 10, which results in a two-fold periodicity. It is further provided that the ratio of tooth width B to groove spacing τ, considered for each tooth 16, is constant. As a result, all teeth 16 have the same ratio.

In FIG. 2, an electrical machine 30 is shown in a schematic depiction, the electrical machine including a stator 33 and rotor 10 according to the present invention. It is provided that stator 33 has a four-pole configuration.

If rotor 10 does not have a rotationally symmetric or point-symmetric configuration, rotor 10 can become imbalanced. To eliminate the imbalance of rotor 10, it is provided that grooves 39 are machined on the radially outwardly directed side, in tooth tips 36, for example, to eliminate imbalances. For the same purpose, it can also be provided that a tooth 16 have an opening 42 which is situated such that it only minimally influences the electromagnetic properties.

1. A rotor for an electrical machine (30), in particular a short-circuited rotor for an asynchronous machine, with alternating teeth (16) and grooves (13) on the periphery,
wherein groove spacing (τₙ) is not constant.

2. The rotor as recited in claim 1,
wherein the groove spacing (τₙ) on the periphery alternatingly increases and decreases.

3. The rotor as recited in claim 2,
wherein the groove spacing (τₙ) on the periphery is alternatingly larger and smaller, and is determined based on an at least approximately sine-dependent function.

4. The rotor as recited in claim 2 or 3,
wherein the groove spacing around the periphery increases and decreases twice.

5. The rotor as recited in one of the preceding claims,
wherein a ratio of tooth width (B) and groove spacing (τ) is constant.

6. The rotor as recited in one of the preceding claims,
wherein the rotor (10) is symmetrically configured.

7. An electrical machine (30) with a stator (33) and a rotor (10) as recited in one of the preceding claims.

8. The electrical machine as recited in claim 7,
wherein the stator (33) is four-poled.
